(19) United States
(12) Patent Application Publication
(10) Pub. No.: US 2016/0114772 A1
(43) Pub. Date: Apr. 28, 2016

(54) METHODS AND SYSTEMS FOR BOOSTING TRAILER BRAKE OUTPUT

(71) Applicant: GM GLOBAL TECHNOLOGY OPERATIONS LLC, Detroit, MI (US)

(72) Inventors: EDWARD A. VIETOR, FARMINGTON HILLS, MI (US); KATHERIN L. HARTMAN, BRIGHTON, MI (US)

(21) Appl. No.: 14/523,503

(22) Filed: Oct. 24, 2014

(51) Int. Cl. B60T 8/17; B60T 8/18; B60T 8/32; B60T 8/172

(52) U.S. Cl. CPC B60T 8/1708; B60T 8/172; B60T 8/1887; B60T 8/323

(57) ABSTRACT

Methods and systems are provided for controlling a brake system of a trailer associated with a vehicle. In one embodiment a method includes: determining a brake output based on brake pressure of a vehicle brake system, a deceleration of the vehicle, and a braking torque of the vehicle; applying a boost factor to the brake output resulting in an adjusted brake output; and generating a control signal based on the adjusted brake output.

### TECHNICAL FIELD

The present disclosure generally relates to brake systems of a trailer, and more particularly relates to methods and systems for controlling a brake output of a brake system of a trailer.

### BACKGROUND

A trailer can include a brake system that provides a braking force to wheels of the trailer to bring the vehicle and the trailer to a stop. Some brake systems are electronically controlled systems that require an electrical connection to the tow vehicle in order to receive a control signal. The control signal can include a voltage- and/or current-controlled signal that is proportional to a driver braking intent (DBI). The brake systems receive the control signal and cause a braking force to be applied via a disc or drum (either hydraulic or electric/magnetic).

A control module of the vehicle evaluates vehicle conditions and generates the control signals. In some cases, the control signals do not control an available maximum brake output of the brake system. Accordingly, it is desirable to provide methods and systems for generating control signals to boost the trailer brake output. Furthermore, other desirable features and characteristics of the present invention will become apparent from the subsequent detailed description of the invention and the appended claims, taken in conjunction with the accompanying drawings and this background of the invention.

### SUMMARY

Methods and systems are provided for controlling a brake system of a trailer associated with a vehicle. In one embodiment, a method includes: determining a brake output based on at least one of a brake pressure of a vehicle brake system, a deceleration of the vehicle, and a braking torque of the vehicle; applying a boost factor to the brake output resulting in an adjusted brake output; and generating a control signal based on the adjusted brake output.

In one embodiment, a system includes a first module that determines a brake output based on at least one of a brake pressure of a vehicle brake system, a deceleration of the vehicle, and a braking torque of the vehicle. The system further includes a second module that applies a boost factor to the brake output resulting in an adjusted brake output. The system further includes a third module that generates a control signal based on the adjusted brake output.

In one embodiment, a system includes a vehicle having a brake system and a control module. The control module determines a brake output based on at least one of a brake pressure of the brake system of the vehicle, a deceleration of the vehicle, and a braking torque of the vehicle, applies a boost factor to the brake output resulting in an adjusted brake output, and generates a control signal to the brake system of the trailer based on the adjusted brake output.

### DESCRIPTION OF THE DRAWINGS

The present disclosure will hereinafter be described in conjunction with the following drawing figures, wherein like numerals denote like elements, and:

FIG. 1 is a functional block diagram of a vehicle and trailer that includes, among other features, a trailer brake system in accordance with exemplary embodiments;

FIG. 2 is a dataflow diagram illustrating a control module of the trailer brake system in accordance with exemplary embodiments; and

FIG. 3 is a flowchart of a method of controlling the trailer brake system in accordance with exemplary embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

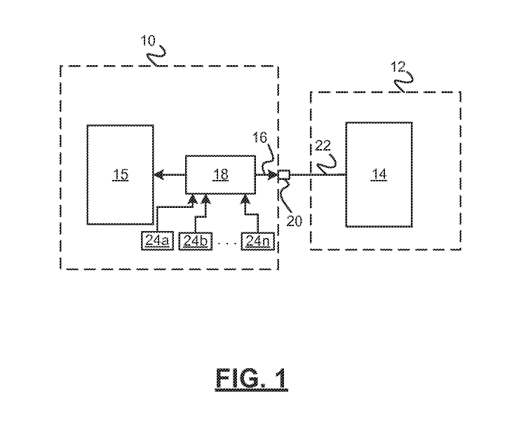

With reference to FIG. 1, a vehicle 10 is shown to be associated with a trailer 12 having a brake system 14 in accordance with exemplary embodiments. The vehicle 10 may be any vehicle having a brake system 15, including but not limited to, an automobile, a truck, and a sport utility vehicle. The trailer 12 may be any trailer 12 having a brake system 14; and the brake system 14 may be any brake system, including, but not limited to, a surge brake system, an electric brake system, and an electric-over-hydraulic brake system. Although the figures shown herein depict an example with certain arrangements of elements, additional intervening elements, devices, features, or components may be present in an actual embodiment. It should also be understood that FIG. 1 is merely illustrative and may not be drawn to any type of scale.

The brake system 14 of the trailer 12 is electronically controlled. That is, the brake system 14 receives control signals 16 from a control module 18 and controls a braking force based on the control signals 16. In various embodiments, as shown in FIG. 1, the control module 18 resides on the vehicle 10 and controls the vehicle brake system 15. The control module 18 communicates the control signals 16 to the trailer 12 according to a wired or wireless communication protocol. For example, in the embodiment shown, the control module 18 communicates the controls signals 16 through an electrical connector 20 of the vehicle 10 that connects to a wiring harness 22 of the trailer 12. Alternatively, the control module 18 communicates the control signals 16 through a wireless transceiver (not shown) of the vehicle 10 that communicates with a wireless transceiver (not shown) of the trailer 12. In various other embodiments, not shown, the control module 18 may reside on the trailer 12 and may receive data from the vehicle 10 through the electrical connector 20 and wiring harness 22 connected to a vehicle bus (not shown) and/or other control module (not shown) of the vehicle 10.

In any of the embodiments, the control module 18 generates the control signals 16 based on vehicle data. The vehicle data may be received from sensors 24a-24n of the vehicle 10, and/or determined by the control module 18 or other control modules (not shown) of the vehicle 10. In general, the control module 18 determines a brake output and, in some instances, adjusts the brake output by a boost factor. The boost factor is determined based on vehicle data. The control module 18 generates the control signals 16 based on the adjusted brake output.

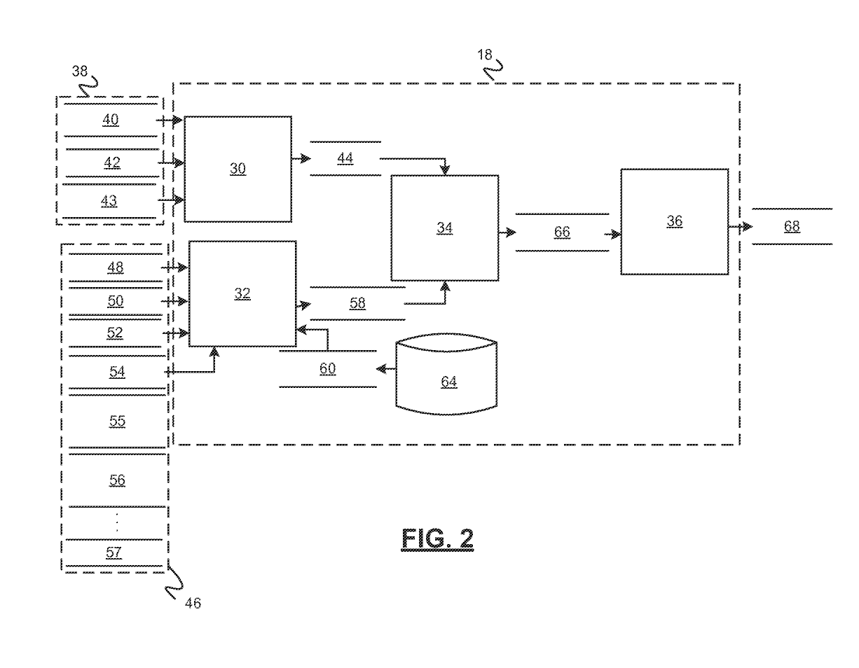

Referring now to FIG. 2 and with continued reference to FIG. 1, a dataflow diagram illustrates the control module 18 in accordance with various embodiments. Various embodiments of the control module 18 according to the present disclosure may include any number of sub-modules. As can be appreciated, the sub-modules shown in FIG. 2 may be combined and/or further partitioned to similarly generate control signals 16 to the brake system 14 of the trailer 12. Inputs to the control module 18 may be received from the sensors 24a-24n, may be received from other control modules (not shown) of the vehicle 10, and/or may be determined by other sub-modules (not shown) of the control module 18. In various embodiments, the control module 18 includes a brake output determination module 30, a boost factor determination module 32, a brake output adjustment module 34, and a control signal generation module 36.

The brake output determination module 30 receives as input vehicle data 38, such as brake pressure data 40, deceleration data 42, and/or brake torque data 43. The brake pressure data 40 indicates a pressure of the vehicle brake system 15. The deceleration data 42 indicates a deceleration rate of the vehicle 10 and/or trailer 12. The brake torque data 43 indicates an estimated torque that is being applied by the vehicle brake system 15.

Based on the vehicle data 38, the brake output determination module 30 determines a brake output 44. For example, the brake output determination module 30 determines a brake output value that is proportional to the brake pressure data 40. In another example, the brake output determination module 30 determines a brake output value that is proportional to the deceleration data 42 when, for example when an anti-lock brake function of the vehicle brake system 15 is being performed. In still other examples, the brake output determination module 30 determines a brake output value that is proportional to the brake torque data 43. As can be appreciated, any known method of determining brake output 44 may be used including that described in U.S. Pat. No. 8,165,768 which is incorporated herein by reference. The brake output determination module 30 provides the brake output 44 to the brake output adjustment module 34.

The boost factor determination module 32 receives as input vehicle data 46 such as, but not limited to, load data 48, speed data 50, deceleration data 52, a trailer brake type data 54, surface coefficient data 55 (e.g., an actual value between 0 and 1), surface classification data 56 (e.g., gravel, ice, asphalt, etc.), and/or grade data 57 (e.g., a percent grade of the road currently traveled). In various embodiments, the load data 48 indicates a load of the vehicle 10, a load of the vehicle 10 and the trailer 12, and/or a load of the trailer 12. The speed data 50 indicates the speed of the vehicle 10. The deceleration data 52 indicates a deceleration of the trailer 12 and/or the vehicle 10. The trailer brake type data 56 indicates a brake type of the trailer 12.

The boost factor determination module 32 determines a boost factor 58 based on the vehicle data 46. For example, the boost factor determination module 32 determines a boost factor value 60 from a boost factor curve. The boost factor curve is defined by the vehicle data 46 and may include values ranging from 1 to 2 or any other value.

In various embodiments, the boost factor curve may be predefined and stored as a lookup table in a boost factor curve datastore 64. As can be appreciated, any number of lookup tables can be stored in the boost factor curve datastore 64. For example, the boost factor curve datastore 64 may store lookup tables with boost factor curves defined for brake pressure and load, load and speed, deceleration and load, trailer brake type, grade, and/or any combination of the vehicle data 46. The boost factor determination module 32 selects the lookup table for use based on the vehicle data 46 received. For example, when load data 48 is received the boost factor determination module 34 selects the lookup table that is indexed by load and determines the boost factor value 60 based on the value of the load data 48. The boost factor determination module 32 provides the boost factor 58 to the brake output adjustment module 34.

The brake output adjustment module 34 receives as input the brake output 44 and the boost factor 58. The brake output adjustment module 34 adjusts the brake output 44 based on the boost factor 58. For example, the brake output adjustment module 34 adjusts the brake output 44 by applying (e.g., multiplying) the boost factor 58 to the brake output 44 to boost the brake output 44. The brake output adjustment module provides the adjusted brake output 66 to the control signal generation module 36.

The control signal generation module 36 receives as input the adjusted brake output 66. The control signal generation module 36 generates a control signal 68 to control the brake system 14 of the trailer 12 based on the adjusted brake output 66. In various embodiments, the control signal generation module 36 generates the control signal 68 simply based on the adjusted brake output 66 or based on the adjusted brake output 66 and other factors such as, but not limited to, a voltage of the vehicle 10.

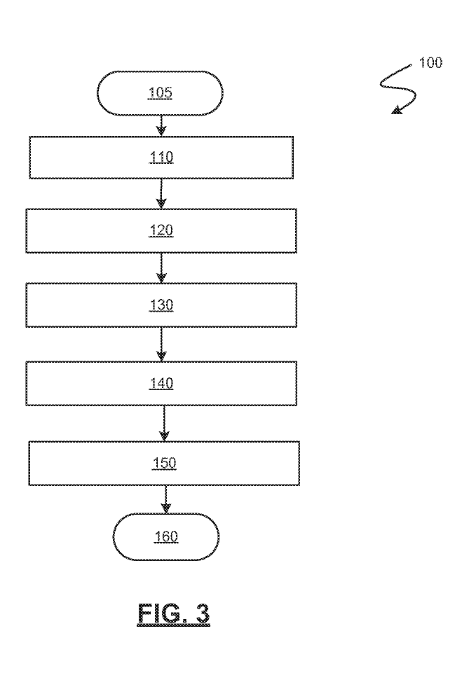

With reference now to FIG. 3, a flowchart of a method 100 for generating a control signal 68 is shown in accordance with exemplary embodiments. The method 100 can be utilized in connection with the vehicle 10 and the trailer 12, in accordance with exemplary embodiments. As can be appreciated in light of the disclosure, the order of operation within the method 100 is not limited to the sequential execution as illustrated in FIG. 3, but may be performed in one or more varying orders as applicable and in accordance with the present disclosure.

As can be appreciated, the method 100 may be scheduled to run based on predetermined events and/or may be run automatically at predetermined time intervals. As depicted in FIG. 3, the method may begin at 105. The brake output 44 is determined based on the brake pressure 40, the deceleration 42, and/or the braking torque 43 at 110. The vehicle data 46 is determined at 120. The boost factor 58 is determined based on the vehicle data 46 at 130. The boost factor 58 is applied to the brake output 44 resulting in the adjusted brake output 66 at 140. The control signal 68 is generated based on the adjusted brake output 66 at 150. Thereafter, the method may end at 160.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A control method for controlling a brake system of a trailer associated with a vehicle, the control method comprising:
determining a brake output based on at least one of brake pressure of a vehicle brake system, a deceleration of the vehicle, and a braking torque of the vehicle;
applying a boost factor to the brake output resulting in an adjusted brake output; and
generating a control signal based on the adjusted brake output.

2. The control method of claim 1, further comprising determining the boost factor based on vehicle data.

3. The control method of claim 2, wherein the vehicle data includes load data.

4. The control method of claim 3, wherein the load data indicates at least one of a vehicle load, a trailer load, and a vehicle and trailer load.

5. The control method of claim 2, wherein the vehicle data includes vehicle speed data.

6. The control method of claim 2, wherein the vehicle data includes deceleration data.

7. The control method of claim 2, wherein the vehicle data includes at least one of a surface coefficient, a surface type, and a grade of the surface the vehicle is traveling.

8. The control method of claim 2, wherein the vehicle data includes trailer brake type data.

9. The control method of claim 1, wherein the applying comprises multiplying the boost factor by the brake output resulting in the adjusted brake output.

10. The control system of claim 1, further comprising modifying the control signal based on a voltage of the vehicle.

11. A control system for controlling a brake system of a trailer associated with a vehicle, the system comprising:
a first module that determines a brake output based on at least one of brake pressure of a vehicle brake system, a deceleration of the vehicle, and a braking torque of the vehicle;
a second module that applies a boost factor to the brake output resulting in an adjusted brake output; and
a third module that generates a control signal based on the adjusted brake output.

12. The control system of claim 11, further comprising a fourth module that determines the boost factor based on vehicle data.

13. The control system of claim 12, wherein the vehicle data includes load data, and wherein the load data indicates at least one of a vehicle load, a trailer load, and a vehicle and trailer load.

14. The control system of claim 12, wherein the vehicle data includes vehicle speed data.

15. The control system of claim 12, wherein the vehicle data includes deceleration data.

16. The control system of claim 12, wherein the vehicle data includes at least one of surface coefficient, a surface type, and a grade of the surface the vehicle is traveling.

17. The control system of claim 12, wherein the vehicle data includes trailer brake type data.

18. The control system of claim 11, wherein the second module applies the boost factor by multiplying the boost factor by the brake output resulting in the adjusted brake output.

19. The control system of claim 11, wherein the third module modifies the control signal based on a voltage of the vehicle.

20. A system for controlling a brake system of a trailer, the system comprising:
a vehicle having a brake system; and
a control module that determines a brake output based on at least one of brake pressure of the brake system of the vehicle, a deceleration of the vehicle, and a braking torque of the vehicle that applies a boost factor to the brake output resulting in an adjusted brake output, and that generates a control signal to the brake system of the trailer based on the adjusted brake output.
